(19) United States
(12) Patent Application Publication
(10) Pub. No.: US 2015/0178447 A1
(43) Pub. Date: Jun. 25, 2015

(54) METHOD AND SYSTEM FOR INTEGRATING MEDICAL IMAGING SYSTEMS AND E-CLINICAL SYSTEMS

(71) Applicant: Medidata Solutions, Inc., New York, NY (US)

(72) Inventors: Jeffrey Cohen, Merrick, NY (US); Joseph Dustin, Hampton, NJ (US)

(73) Assignee: Medidata Solutions, Inc., New York, NY (US)

(21) Appl. No.: 14/134,489

(22) Filed: Dec. 19, 2013

(51) Int. Cl. G06F 19/00

(52) U.S. Cl. CPC G06F 19/321

(57) ABSTRACT

The present invention provides an imaging service method and system by which medical images stored in the DICOM standard in a central medical imaging repository may be seamlessly and securely accessed, and operated on, by electronic data capture (EDC) or eClinical data systems. The interoperability between web-based Medical Imaging Repositories and eClinical systems provided by the present invention may increase data quality and visibility to clinical workflow involving medical imaging, decrease delays in accessing images and their clinical measurements, and improve the functionality of DICOM-based MIR systems by providing measurement-based versions.

### BACKGROUND

Various strides have improved the creation, handling, transmission and storage of medical images commonly used for routine patient care and for multi-center clinical studies, such as the DICOM data standard for medical images, Picture Archiving and Communication System (PACS) for image storage and access, and the Web access to DICOM object (WADO) web-standardized image service. Other technology strides have advanced the creation, handling, transmission and storage of clinical data, such as modern Electronic Data Capture (EDC) and eClinical systems (web-based systems used for the capture of clinical trial data, including clinical and operational data, such as EDC and clinical data management (CDM) systems).

### BRIEF DESCRIPTION OF THE DRAWINGS

FIG. 1 is a block diagram illustrating the relationship of an imaging service to an imaging system (a Medical Imaging Repository (“MIR”) and a Picture Archiving and Communication System (PACS)) and to an eClinical system, according to an embodiment of the present invention;

FIG. 2 is a schematic illustrating the operation of an aspect of an embodiment of the present invention;

FIGS. 3A-3D are flow diagrams illustrating the operation and use of the imaging service according to embodiments of the present invention; and

FIG. 4 is a screenshot illustrating a use of the imaging service, according to an embodiment of the present invention.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Embodiments of the present invention may be used in a variety of applications. For example, in addition to clinical trial-related uses, the invention may be used in healthcare systems such as Electronic Health Records (EHR) or Electronic Medical Records (EMR) systems.

Presently, medical images are created by x-ray machines, MRI scanning machines, etc., and are stored at imaging databases local to the clinical sites (hospitals, outpatient radiology clinics, etc.) in which they were created. Medical images may then be uploaded in different ways to a central medical imaging repository (“MIR”) (also referred to in the plural herein), such as DICOM servers at centralized sites or “core labs.” For example, while a technician may initially generate medical images at a local device/site, clinical trial personnel such as a radiologist or a clinical research coordinator may later retrieve the images from the local imaging databases on which they were stored (e.g., a hospital image shared drive or PACS system) and upload them into the MIR (including through individual or batch (bulk) uploading). In the MIR system, the images may be stored in a database, each image with its own metadata, such as a unique image identifier (often a universally unique identifier (UUID)), “deep-linking” data to facilitate web-based retrieval (e.g., data that facilitate the retrieval of an image from the MIR without additional authentication, often through variables passed in a URL), and scan description tags (e.g., data that indicate the modality of an image, such as MRI, X-ray, CT), etc. Alternatively, a Study Coordinator may burn the images from the local imaging database to DVD, fill out a transmittal form, and ship the images to a central repository (MIR) for upload by personnel there.

Once uploaded to a centralized imaging repository, the medical images may be available for review by a radiologist, cardiologist or other clinician as part of standard delivery of care and/or use as clinical trial data. Disadvantageously, clinical measurements then made based on the medical images (e.g., measurements of tumor sizes) are typically recorded on local systems separate from an imaging repository or from a centralized eClinical system, and are only later manually incorporated into an eClinical system, e.g., a web-based system used for the capture of clinical trial data, including clinical data and related operational data (such as audit data, timestamps, machine source identifying information, routing information, etc.). From the perspective of the quality of data and efficiency of operation of a clinical trial, the current discontinuous systems and workflow create unnecessary delay, data transcription errors, quality issues, and lack of operational insight.

Thus, despite the strides described above in the creation, handling, transmission and storage of medical images commonly used for routine patient care and for multi-center clinical studies as well as strides in the creation, handling, transmission and storage of clinical data, such as modern EDC and eClinical systems, there remain several challenges in using medical images for clinical trials. Those challenges include image transport (expensive, time-delayed shipping between image scanning sites and core labs where images are reviewed by experts), workflow (lack of centralized tracking; use of disparate or non-integrated systems for the recordation by experts of clinical observations of reviewed images, such as Microsoft® Excel®), and technology (disparate thick-client installed imaging components for which access to data or functionality is offline, siloed, and/or isolated; lack of historic versions in stored DICOM images).

The present invention addresses the above-described challenges to the use of medical images in or for clinical trials by providing an imaging service method and system by which medical images stored in the DICOM standard in a central medical imaging repository may be seamlessly and securely accessed, and operated on, by EDC or eClinical data systems. The interoperability between web-based Medical Imaging Repositories and eClinical systems provided by the present invention may increase data quality and visibility to clinical workflow involving medical imaging, decrease delays in accessing images and their clinical measurements, and improve the functionality of DICOM-based MIR systems by providing measurement-based versions. Another benefit of the present invention is that it allows for the “plug and play” of commercially available web-based medical imaging repositories with eClinical systems without the need for costly custom integrations and additional testing.

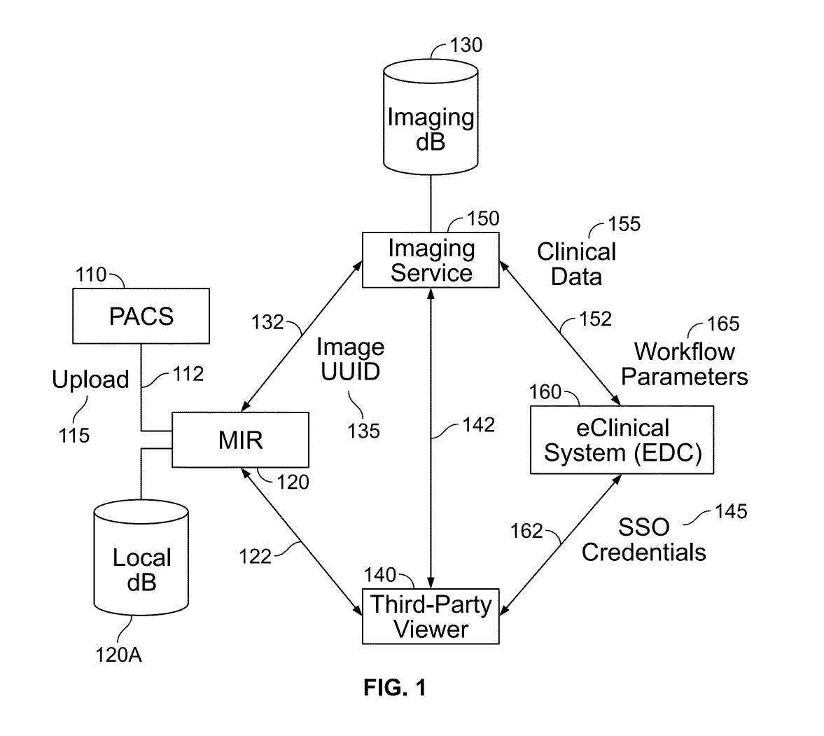

Reference is now made to FIG. 1, a block diagram illustrating the relationship between imaging service 150, MIR 120 and eClinical system 160. Imaging service 150, which as utilized herein may itself be a component of eClinical system 160 or may be free-standing with its own user interface, may provide the relationship between medical images stored in MIRs (along with their associated data) and workflow data (e.g., workflow parameters) in eClinical systems. A medical image stored in the DICOM standard may be originated at a local system such as a Picture Archiving and Communication System (PACS) 110, may subsequently be uploaded to and stored in MIR 120 (a DICOM server) (together, the “imaging system” of the prior art), and may then be viewable with third-party image viewer 140, such as a PACS image viewer. (An image viewer is “third-party,” as described in the present disclosure, where it is not an integrated component of eClinical system 160.) A unique image identifier (e.g., Image UUID 135), generated as a result of the operation of upload 115 of the image to MIR 120, may be captured by imaging service 150, and then may be persisted (stored) in imaging database 130 of imaging service 150. Imaging service 150 may associate the created Image UUID 135 with workflow parameters 165 received from eClinical system 160. The workflow parameters may include data from an electronic case report form (eCRF) of eClinical system 160, such as the patient (subject), visit (or point in time), study, and site. It is noted that in some embodiments of the present invention, where MIR 120 may not generate a unique image identifier, imaging service 150, via connection 132, may also generate as well as capture a unique image identifier as a result of upload 115 to MIR 120.

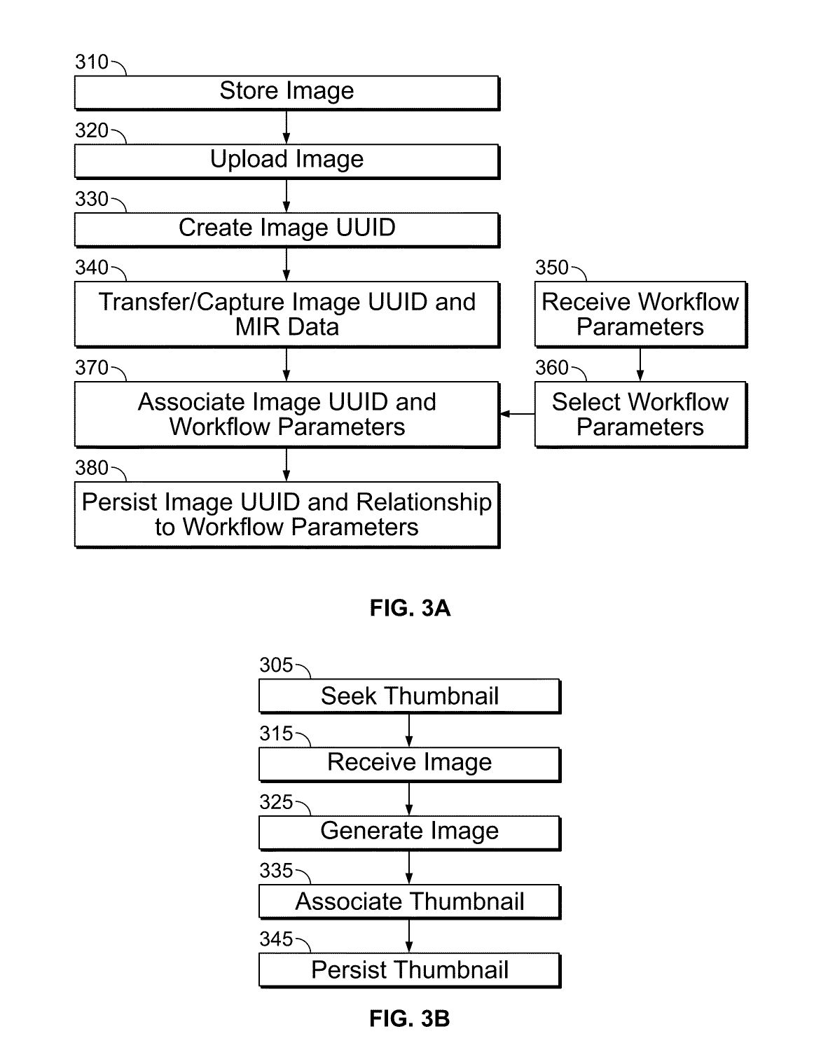

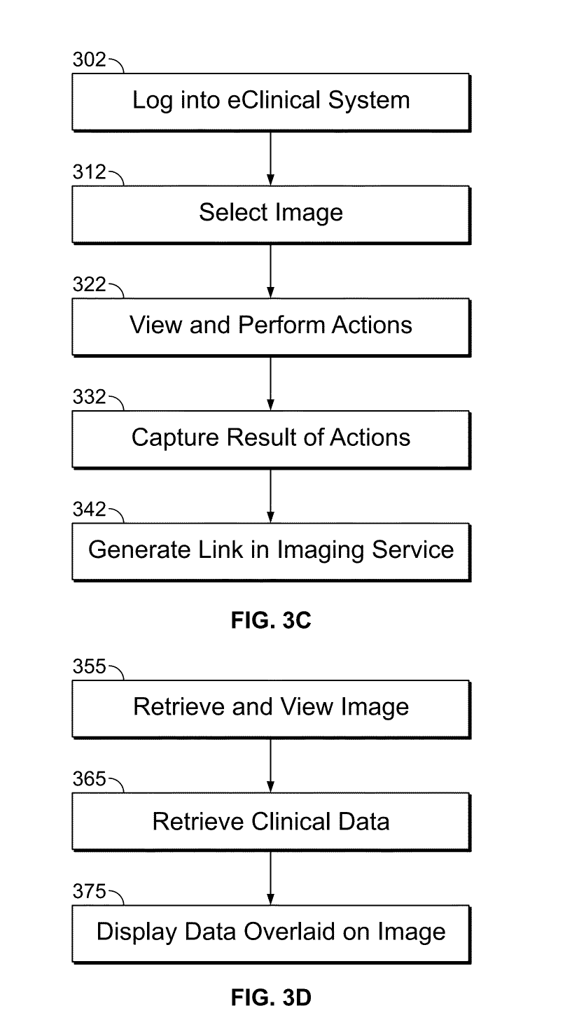

Imaging service 150 may further capture audit data from MIR 120 associated with an uploaded image and/or with MIR 120 itself. Audit data may include data regarding the who, when, where, and what of an action, such as the upload or retrieval of an image from PACS 110 to MIR 120, or the download of a medical image from MIR 120 to local database 120A. The workflow parameters and/or the audit data associated with Image UUID 135 may then be persisted (stored) in imaging database 130 of imaging service 150 and may be advantageously accessed and utilized through imaging service 150 by a user of eClinical system 160 (a data manager, clinical research associate, etc.) so that the user may retrieve the status of images generated for a given patient, visit (or point in time), site, and study (e.g., eCRF data, further described with reference to FIG. 3A).

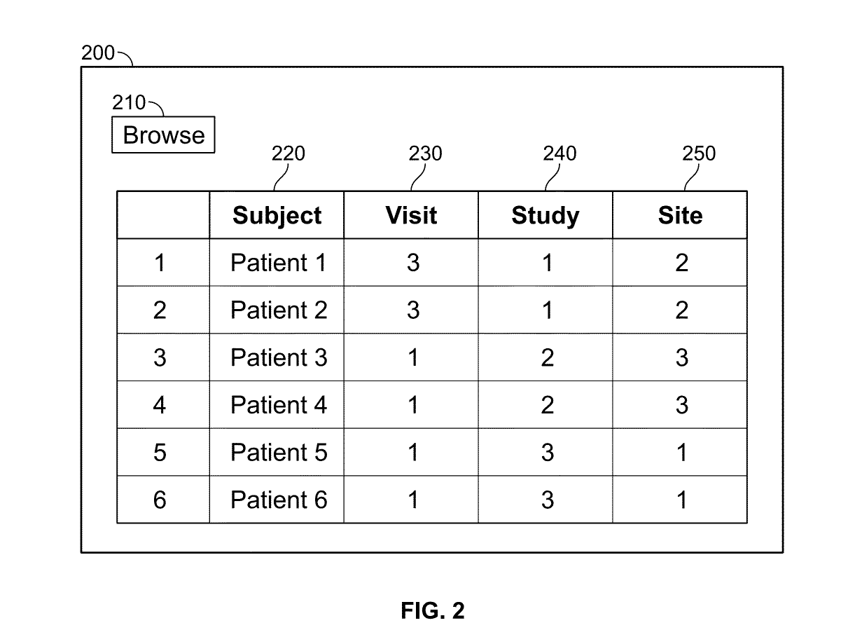

In more detail, when site personnel, such as a study coordinator or a clinical research coordinator, utilize upload 115 to upload one or more medical images to MIR 120 from PACS 110, they may associate workflow parameters, such as study, subject and site data (e.g., study, subject and site identifiers) with the uploaded images. Such workflow parameters (e.g., unique identifiers such as UUIDs) may be made available to MIR 120 from eClinical system 160 via imaging service 150. As shown in FIG. 2, where several images are uploaded (a batch upload) with the operation of upload 115, a user may upload medical images in browser 200 (by clicking on browse button 210), and may then apply workflow parameters to each image, such as subject 220, visit (or time point) 230, study 240, and site 250. For example, the images for a first and second patient may correspond to their participation in each of their third visits for a first study at a second site; images for a third and fourth patient may be for their first visits for a second study at a third site, and for a fifth and sixth patient, the images may be for their first visits for yet a different study at a first site. With the upload 115 of a medical image to MIR 120, the generated Image UUID 135 may then be captured in imaging service 150; imaging service 150 then may also automatically link (relate or associate) Image UUID 135 with the eClinical system-derived workflow parameters 165, e.g., study, subject, visit, and site identifiers, as well as data identifiers of an eCRF or an eCRF field. Thus both MIR 120 and eClinical system 160 may have their own ways of generating their own unique identifiers (e.g., Image UUIDs and workflow-related UUIDs, respectively), and imaging service 150 may capture both types of UUIDs and may persist the relationship between the two, including by generating and persisting a unique identifier of that relationship.

The present invention may provide that the operation of upload 115 (a batch upload or an individual image upload) to MIR 120 automatically transfers the created Image UUID to imaging service 150 via an application programming interface (“API”) call to eClinical system 160. Data captured from MIR 120 associated with a given image and stored in imaging database 130 of imaging service 150 may include where MIR 120 is located, and how to access its images, e.g., scan descriptions and deep-linking data, data regarding the originating PACS 110 itself, and data indicating whether an image may be retrieved directly or if only a thumbnail is available for retrieval (“MIR data”). For example, based on MIR data associated with a given Image UUID, an eCRF displayed in eClinical system 160 may retrieve and display a thumbnail of an image or a link to it via connections 132 and 152 from the thumbnail hosted on MIR 120. Imaging service 150 may also be configured to communicate and interoperate with different third-party image viewers, utilizing standards provided by WADO-enabled viewers, via connection 142.

As further described with reference to FIG. 3B, in the case in which a thumbnail is not supplied in association with an image, the present invention may also dynamically generate the thumbnail based on a subset of imaging data points (not pictured). For example, imaging service 150 may receive via connection 132 a subset of imaging data points from MIR 120 in order to dynamically manipulate the image with standard image conversion software to generate a thumbnail; the thumbnail may be persisted in imaging database 130 of imaging service 150 and may be accessible to eClinical system 160.

The connections (e.g., 112, 122, 132, 142, 152) between the components in FIG. 1 may utilize API calls. For example, utilizing API calls, third-party viewer 140 in use by a user such as a Study Coordinator may utilize clinical data 155 received from eClinical system 160 via connection 152, in turn from imaging service 150 via connection 142. Clinical data 155 may include clinical measurements (“measurement data”) based on a medical image viewed by the user in third-party viewer 140. In the opposite direction, measurement data generated by a user in third-party viewer 140 may in turn be received by and stored in eClinical system 160 via connection 142 to imaging service 150 and then via connection 152 to eClinical system 160. Measurement data generated by a user viewing an image in third-party viewer 140 may also be received by eClinical system 160 via connection 152 with imaging service 150, in turn via connection 132 with MIR 120, in turn via connection 122 with third-party viewer 140. Further, a user or form (e.g., an eCRF) of eClinical system 160 may seek to retrieve an image from MIR 120 utilizing API calls via connection 152 from imaging service 150 and in turn from API calls via connection 132 with MIR 120. Image retrieval by a user of eClinical system 160 may then require display of the image in third-party viewer 140, which viewer 140 may utilize API calls via connection 122 with MIR 120. In addition, MIR 120 may receive via connection 132 measurement data from imaging service 150, in turn from eClinical system 160 via connection 152, as well as other data, such as comments, that may be utilized as part of an image record (such as EMR data) stored in MIR 120. Connection 162 may be a URL-based deep-link connection between third-party viewer 140 and eClinical system 160 utilized for single sign-on interoperability between those components (described further with reference to FIG. 3C). Thus, where a user of eClinical system 160 is manipulating images in third-party viewer 140 (or where third-party viewer 140 receives an image from MIR 120 after a request from eClinical system 160 through imaging service 150), third-party viewer 140 may be launched seamlessly (from the point of view of the user) from eClinical system 160 via connection 162, or via API connections 152 (to imaging service 150), 132 (to MIR 120), and 122 (to third-party viewer 140).

Imaging service 150 may further address a shortcoming with images stored in the DICOM standard: because DICOM image metadata is not altered by clinical measurements taken based on an image, it may not be possible currently to save and retrieve historic versions of the measurements overlaid on those images. By storing clinical data 155, such as measurement data based on an image, in eClinical system 160 and not storing that clinical data 155 with the image itself in MIR 120, clinical data 155 may be retrieved along with the image itself and may act as a snapshot in time of the image. Such snapshots in time may be retrieved and displayed by layering the clinical data 155 on top of the image, and may be utilized as measurement-based versions of the image. In order to overlay clinical data 155 on an associated image, imaging service 150 may retrieve clinical data 155 from eClinical system 160 via an API call over connection 152, retrieve the associated image stored in MIR 120 via an API call over connection 132, and cause the image and the associated measurement data to be displayed via an API call over either connection 142 or connections 132 and 122 in third-party viewer 140. Multiple layers of clinical data may be overlaid where each layer may correspond to various clinical data 155, such as the date on which the clinical data were generated.

Reference is now made to FIGS. 3A-3D, which are flow diagrams illustrating the operation and use of imaging service 150 of some embodiments of the present invention, including creating the associations described herein and their use for clinical purposes in conjunction with PACS 110, MIR 120 and eClinical system 160.

As shown in FIG. 3A, a medical image may be stored in PACS 110 in operation 310. A user of eClinical system 160 (e.g., an EDC system), such as a study coordinator, clinical research coordinator, etc., in operation 320 may upload the medical image to MIR 120, by which, in operation 330, an Image UUID 135 may be created (generated) by MIR 120 (or, in some embodiments, by imaging service 150) and may be captured by imaging service 150 in operation 340. The capture of Image UUID 135 in operation 340 may also capture MIR data from MIR 120. The user may receive or browse for workflow parameters 165 in operation 350 from eClinical system 160, and may in operation 360 select those parameters, by which selection Image UUID 135 may be associated with the workflow parameters in operation 370. In operation 380, the association between Image UUID 135 and the workflow parameters 165 may be persisted. Such association may be persisted in a database or may include the creation by imaging service 150 of a unique identifier specific to that association, which identifier may also be persisted.

If not available in association with an image received from MIR 120, a thumbnail of an image may also be generated. For example, as shown in FIG. 3B, in operation 305 imaging service 150 may seek a thumbnail of an image from MIR 120 or from MIR data received and persisted by imaging service 150, and where the thumbnail is not available, may in operation 315 receive the image from MIR 120. In operation 325, imaging service 150 may dynamically manipulate the image with standard image conversion software to generate a thumbnail. Imaging service 150 may associate the created thumbnail with Image UUID 135 in operation 335 and in operation 345 may persist it in imaging database 130.

With regard to utilizing the association between an Image UUID and workflow parameters, as shown in FIG. 3C, a user such as a radiologist or other clinician may present SSO credentials 145 and login to eClinical system 160 in operation 302. With SSO credentials 145 used by the user to log in, imaging service 150 may provide the user access to third-party viewer 140 without requiring the user to re-present login credentials to third-party image viewer 140 or to images accessed from MIR 120. Thus, in operation 312, the user may select (such as by clicking on a link or a thumbnail) from eClinical system 160 a medical image retrieved from MIR 120. The selected medical image may be viewed by the user from within third-party viewer 140, and the user in operation 322 may perform actions, such as making clinical measurements (clinical data 155) based on the medical image using third-party viewer 140. Clinical measurements made or the results of other actions performed in operation 332 may be automatically captured by imaging service 150 and persisted in imaging database 130. Imaging service 150 may then generate the link or relationship between the measurement data or actions performed, the workflow parameters 165, and Image UUID 135 in operation 342, and thus the clinical measurements may be automatically available to the user in eClinical system 160.

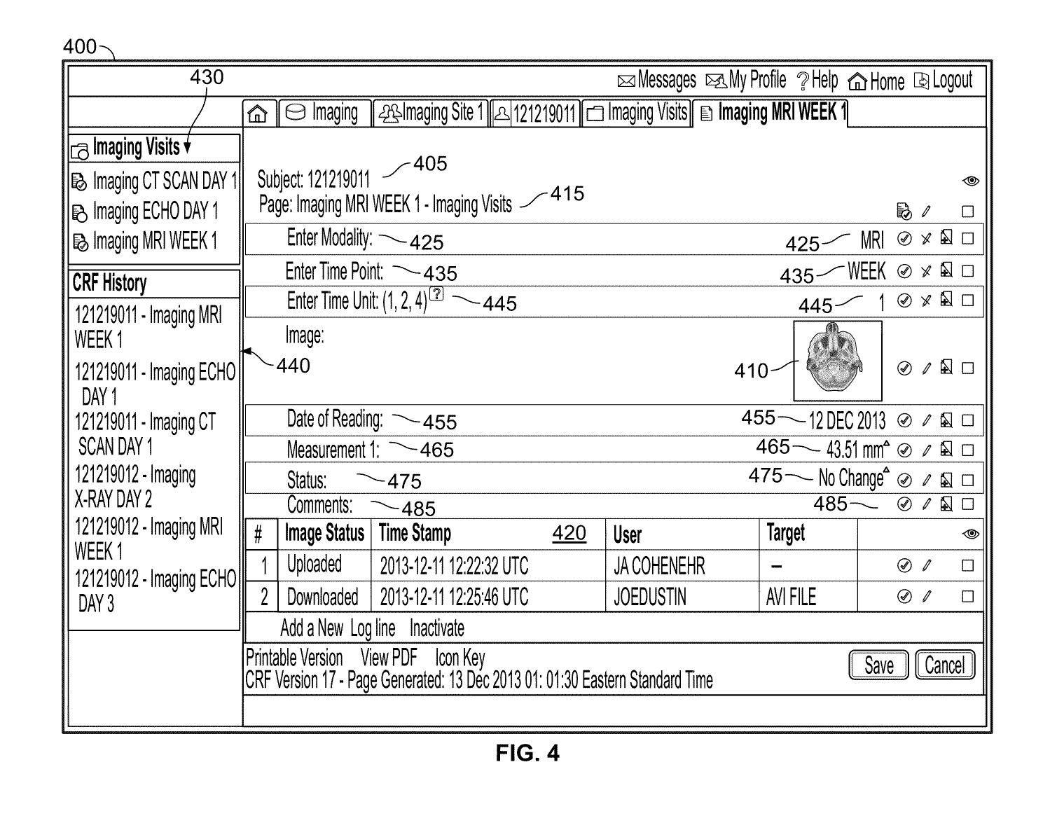

In further detail, others users of the present invention, such as a study coordinator, may also access a medical image in third-party viewer 140 (further described with reference to FIG. 4) after presenting SSO credentials 145 in eClinical system 160 in order to perform actions on the image in operation 322. Such actions may include, in addition to taking measurements of tumor size, stent position, etc., workflow-related actions, downloading the image from MIR 120 to local imaging database 120A. In addition, in contrast to the conventional practice of recording measurements of medical images using separate, isolated programs such as Microsoft® Excel®, the results of such actions performed in operation 322, e.g., clinical endpoint measurements or downloading, may be automatically captured and recorded in real or near real-time in eClinical system 160 and/or an audit trail or system (not pictured) in operation 332. Clinical data generated in operation 322 may then also be received and captured in eClinical system 160 and may be linked with associated Image UUID 135 and workflow parameters 165 from eClinical system 160 in operation 342. Audit information from actions performed in operation 322 may also be captured directly in eClinical system 160 without being received by imaging service 150 (not pictured).

Moreover, a user of eClinical system 160, such as a study coordinator, may determine that a given medical image does not correspond to a patient's particular clinical visit, that is, that the image's workflow parameters were incorrectly created. The user, performing one of the actions in operation 322, may delete the image's linking information (the Image UUID) from imaging service 150.

As shown in FIG. 3D, a user of eClinical system 160 may in operation 355 retrieve a medical image from MIR 120 and view the image with third-party viewer 140. In operation 365, the user may also retrieve stored clinical data 155 from eClinical system 160 that are associated with the image (operation 342) and, in operation 375, the retrieved, associated clinical data may be displayed as overlaid on the image.

Reference is now made to FIG. 4, which is a screenshot illustrating a use of imaging service 150 according to an embodiment of the present invention. Screenshot 400, which may be a screenshot of imaging service 150 utilized within an electronic case report form (eCRF) viewed from eClinical system 160, illustrates the correlation of a medical image—in this case, medical image thumbnail 410—with clinical data and workflow parameters. The workflow parameters include data from eClinical system 160 (e.g., eCRF data) such as specific clinical subject 405, visit or point in time 415, image status 420 (e.g., uploaded or downloaded, by whom, when, and/or where field(s)), history of imaging visits 430, and eCRF history 440, as well as data concerning the image itself that may be obtained from an image's DICOM-standard metadata, such as the image's modality 425, time point entered 435, and time unit 445. Clinical data 155 includes measurement data based on the image, such as the date of the measurement 455, a measurement such as length (e.g., of a tumor) 465, status of the subject of the image 475, and any comments 485. It is noted that data such as image status 420 as well as operational data generated when any measurements (clinical data 155) 455, 465, 475, 485 are made (e.g., who made the measurement, using which third-party viewer, at what time, and any or all changes to the measurement data) may also be audit data and may be passed via API calls from imaging service 150 to eClinical system 160 via connection 152. In further detail, a user such as a radiologist or other clinical expert presented with image 410 may click on it or otherwise request a larger image, which larger image would be seamlessly available to the user in third-party viewer 140 via operation of SSO functionality. Utilizing thumbnail image 410 to access the full image in third-party image viewer 140, the user may make and record measurements within third-party viewer 140, such as measurements 455, 465, 475, 485, which measurement data may be automatically made available to eClinical system 160 in a validated fashion, eliminating the need for a later reconciliation of measurements initially recorded in isolated spreadsheets with their later entry into eClinical system 160. The integration of measurements made in third-party viewer 140 with eClinical system 160 may also eliminate transcription errors and increase the availability of the clinical data to other users of eClinical system 160, such as a CRO or the sponsor of the clinical trial. In addition, workflow-related data 405, 415, 425, 435, 445 may be shared between third-party viewer 140 or MIR 120 and eClinical system 160.

Embodiments of the present invention provide a service by which a live (real or near-real time) endpoint exchange of data may occur between imaging repositories (MIR 120) and eClinical systems 160. Thus, despite previous advances in systems for the creation, handling, transmission and storage of medical images (such as the DICOM data standard for medical images, PACS for image storage and access, and the WADO web-standardized image service), as well as advances in eClinical systems such as EDC (which provide automatic data validation functionality, etc.), there does not exist an integration of those systems with eClinical systems as described in this invention.

Embodiments of the present invention have been described in the context of a distributed network. Examples of such a network include the Internet, an intranet, a wide area network (WAN), or local area network (LAN), and could also include the public switched telephone network (PSTN) or a private telephone network. In some cases, the connections between an MIR and an EDC or other eClinical system may occur within a computer or other type of closed system. The imaging service may be a component of a software application that may run on a computer or that may be part of software as a service (SaaS) or a service-oriented architecture. The imaging service may also be offered as a cloud-based service or hosted service which may be accessed through a standard web service application programming interface (API) or over a RESTful API.

Aspects of the present invention may be embodied in the form of a system, a computer program product, or a method. Similarly, aspects of the present invention may be embodied as hardware, software or a combination of both. Aspects of the present invention may be embodied as a computer program product saved on one or more computer-readable media in the form of computer-readable program code embodied thereon.

For example, the computer-readable medium may be a computer-readable signal medium or a computer-readable storage medium. A computer-readable storage medium may be, for example, an electronic, optical, magnetic, electromagnetic, infrared, or semiconductor system, apparatus, or device, or any combination thereof.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Computer program code in embodiments of the present invention may be written in any suitable programming language. The program code may execute on a single computer or on a plurality of computers. The computer may include a processing unit in communication with a computer-usable medium, wherein the computer-usable medium contains a set of instructions, and wherein the processing unit is designed to carry out the set of instructions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A computer-implemented method for integrating a first clinical system and a second clinical system, the method comprising:
receiving, with a processor, image data relating to an image from the first clinical system;
receiving workflow data from the second clinical system;
capturing a first association between the workflow data and the image data; and
providing, utilizing the first association, access to the first clinical system from the second clinical system.

2. The method of claim 1, wherein the first clinical system is an imaging repository and the second clinical system is an eClinical system.

3. The method of claim 2, wherein the eClinical system is an electronic data capture system.

4. The method of claim 3, wherein the data received from the first clinical system includes scan description tags and deep linking data.

5. The method of claim 4, further comprising receiving an image from a third clinical system for utilizing the image data.

6. The method of claim 5, wherein said third clinical system is an image viewer.

7. The method of claim 6, further comprising receiving measurement data from the image viewer, wherein the measurement data is further associated with the image data and the workflow data.

8. The method of claim 7, further comprising generating a second association between the measurement data and the first association, wherein the second association is persisted with the first association.

9. The method of claim 8, further comprising persisting the measurement data in the electronic data capture system.

10. The method of claim 9, further comprising, utilizing the second association, retrieving the persisted measurement data and retrieving the image from the imaging repository, and displaying, in the image viewer, the measurement data overlaid on the image.

11. A system for integrating a first clinical system and a second clinical system, the system comprising:
the first clinical system containing image data relating to an image;
the second clinical system containing workflow data; and
a third clinical system capable of receiving data from the first clinical system and the second clinical system,
wherein:
the third clinical system receives said image data from the first clinical system and receives said workflow data from the second clinical system;
the third clinical system generates a first association between said image data and said workflow data; and
the first association provides access to the first clinical system from the second clinical system.

12. The system of claim 11, wherein the first clinical system is an imaging repository and the second clinical system is an eClinical system.

13. The system of claim 12, wherein the eClinical system is an electronic data capture system and the third clinical system is an imaging service.

14. The system of claim 13, wherein the imaging service further receives scan description tags and deep linking data from the imaging repository.

15. The system of claim 14, wherein an image viewer utilizes the image data from the imaging service to display the related image from the imaging repository.

16. The system of claim 15, wherein the electronic data capture system receives measurement data from the image viewer, and wherein the imaging service generates a second association between the measurement data and the first association.

17. The system of claim 16, further comprising persisting the second association with the first association.

18. The system of claim 17, wherein the electronic data capture system persists the measurement data.

19. The system of claim 18, wherein the image viewer retrieves the persisted measurement data, retrieves, utilizing the second association, the image from the imaging repository, and displays the measurement data overlaid on the image.
